(19) United States
(12) Patent Application Publication
(10) Pub. No.: US 2024/0362313 A1
(43) Pub. Date: Oct. 31, 2024

(54) SYSTEMS AND METHODS FOR LOCATING A VEHICLE AND IDENTIFYING A SECURITY BREACH

(71) Applicant: FCA US LLC, Auburn Hills, MI (US)

(72) Inventors: Vinoot Handiganoor, Karnatake (IN); Kattinti Siva Krishna, Telangana (IN); Joseph Antony J, Tamil Nadu (IN)

(21) Appl. No.: 18/306,269

(22) Filed: Apr. 25, 2023

(51) Int. Cl. G06F 21/35; G06F 21/56

(52) U.S. Cl. CPC G06F 21/35; G06F 21/566; G06F 2221/034

(57) ABSTRACT

A security system for identifying a security breach of a vehicle is presented. In one exemplary implementation, the security system comprises: an infotainment system, a memory and a controller. The infotainment system has a display and is configured to receive various user inputs. The memory receives and stores data at the infotainment system and is configured to store at least one authorized mobile number associated with the vehicle. The controller (i) determines whether a candidate mobile device has been paired to the infotainment system, (ii) compares a mobile number of the candidate mobile device with the at least one authorized mobile number, (iii) determines a security breach has occurred based on the mobile number of the candidate mobile device not matching at least one authorized mobile number, and (iv) performs a notification action based on the security breach.

### FIELD

The present application generally relates to vehicle security and, more particularly, to systems and methods for identifying a security breach and alerting a vehicle owner of the same.

### BACKGROUND

Existing vehicle security systems can limit vehicle access and/or preclude vehicle operation without proper authentication. Sometimes however, existing security systems can be overcome allowing a vehicle to be stolen or otherwise improperly accessed. Accordingly, while such existing vehicle security systems do work for their intended purpose, there remains a need for improvement in the relevant art.

### SUMMARY

According to one example aspect of the invention, a security system for identifying a security breach of a vehicle is presented. In one exemplary implementation, the security system comprises: an infotainment system, a memory and a controller. The infotainment system has a display and is configured to receive various user inputs. The memory receives and stores data at the infotainment system and is configured to store at least one authorized mobile number associated with the vehicle. The controller (i) determines whether a candidate mobile device has been paired to the infotainment system, (ii) compares a mobile number of the candidate mobile device with the at least one authorized mobile number, (iii) determines a security breach has occurred based on the mobile number of the candidate mobile device not matching at least one authorized mobile number, and (iv) performs a notification action based on the security breach.

In some implementations, the notification action comprises alerting a vehicle owner based on the security breach. The security system can further include a communication system that sends an alert to a secure server through a cellular network indicative of the security breach.

In some implementations, the communication system is configured to communicate a vehicle location to the secure server based on the security breach.

In some implementations, the controller is further configured to set a vehicle stolen diagnostic trouble code based on the security breach.

In some implementations, the memory comprises a non-volatile memory (NVM) module. The NVM module can include a guarded bootloader memory that stores the at least one authorized mobile number.

In some implementations, the at least one authorized mobile number comprises at least five authorized mobile numbers. In other implementations, the at least one authorized mobile number comprises fifteen authorized mobile numbers.

According to another example aspect of the invention, a method for identifying a security breach of a vehicle is presented. In one exemplary implementation, the method comprises: receiving, at an infotainment system of the vehicle, at least one authorized mobile number; storing, at a memory of the infotainment system, the at least one authorized mobile number; determining, at a controller, that a candidate mobile device has been successfully paired to the infotainment system; comparing a mobile number of the candidate mobile device with the at least one authorized mobile number; determining whether a security breach has occurred based on the mobile number of the candidate mobile device not matching at least one authorized mobile number; and performing a notification action based on the security breach.

In some implementations, performing the notification action includes sending an alert to a vehicle owner based on the security breach.

In some implementations, the method further comprises: sending an alert to a secure server through a cellular network indicative of the security breach.

In some implementations, a vehicle location is communicated to the secure server based on the security breach.

In some implementations, a vehicle stolen diagnostic trouble code can be set based on the security breach. Storing the at least one authorized mobile number comprises storing the at least one authorized mobile number at a non-volatile memory (NVM) module. The at least one authorized mobile number can be stored at a guarded bootloader memory.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a functional block diagram of an example vehicle having a security system configured for identifying an unauthorized mobile device user according to the principles of the present disclosure;

FIG. 2 is a schematic illustration of an exemplary memory layout of an infotainment device of the security system of FIG. 1; and

FIG. 3 is a flow diagram of a method of determining whether a paired mobile device is authorized according to the principles of the present disclosure.

### DESCRIPTION

As previously discussed, there remains a need for improvement in the art of vehicle security systems and methods. Accordingly, an improved vehicle security systems and methods for identifying an unauthorized mobile device user of the vehicle is presented.

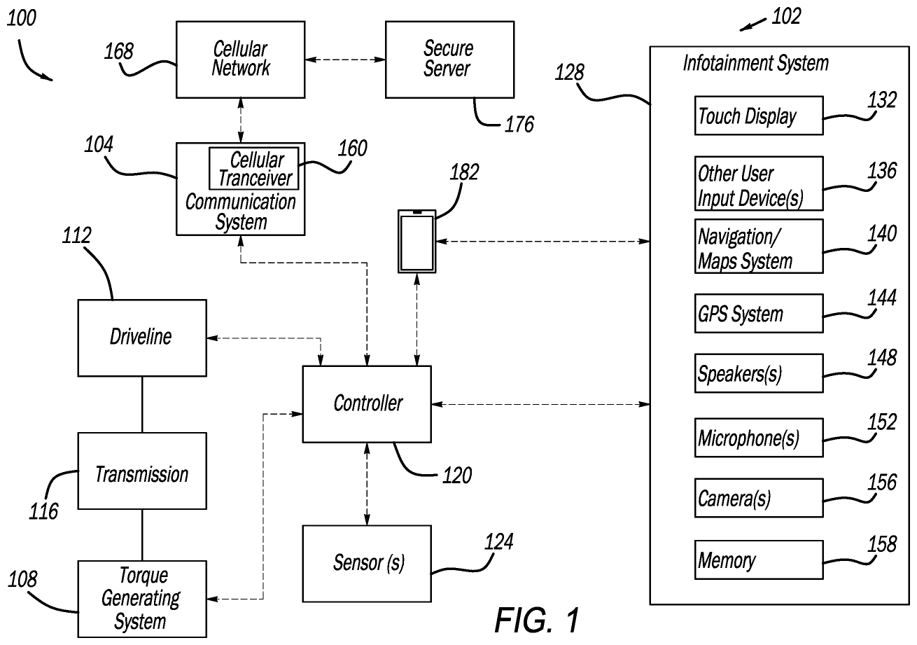

Referring now to FIG. 1, a functional block diagram of an example vehicle 100 having an example security system 102 according to the principles of the present disclosure is illustrated. The security system 102 provides a technique for locating the vehicle 100 and identifying a security breach of the vehicle 100. The vehicle 100 comprises a torque generating system 108 (e.g., an engine, an electric motor, or a combination thereof) that generates drive torque, which is transferred to a driveline 112 via transmission 116 to propel the vehicle 100. The driveline 112 comprises a set of suspension components (axles, differentials, transfer cases, etc.) configured to distribute the drive torque from the transmission 116 to wheels/tires of the driveline 112.

A controller 120 controls operation of the vehicle 100, e.g., based on input(s) from a set of one or more sensors 124. The controller 120 is further configured to communicate with a communication system 104. The communication system 104 comprises a cellular network transceiver 160. The transceiver 160 can be integrated into the vehicle 100 (e.g., as part of the infotainment unit 128) or could be a separate or standalone device. The cellular network transceiver 160 is configured to communicate via a cellular network 168. The vehicle 100 is able to access a secure server or network 176. The terms “secure server” and “secure network” as used herein refers to one or more remote servers that is/are only accessible to authorized users, such as a particular type or brand of vehicle.

In one exemplary implementation, the vehicle 100 comprises an infotainment system 128 comprising at least one of a touch display 132 configured to display information and receive touch input from user(s). The infotainment system 128 includes other user input device(s) 136 (e.g., steering wheel controls), a navigation/maps system 140, a GPS system 144, a set of one or more speakers 148, a set of one or more microphones 152, a set of one or more cameras 156, and a memory 158. It will be appreciated that the infotainment system 128 could comprise additional components that are not illustrated and/or that some of the components illustrated as being part of the infotainment system 128 could be combined or could be separate systems that are merely in communication with the infotainment system 128, e.g., via a localized network, such as a controller area network (CAN).

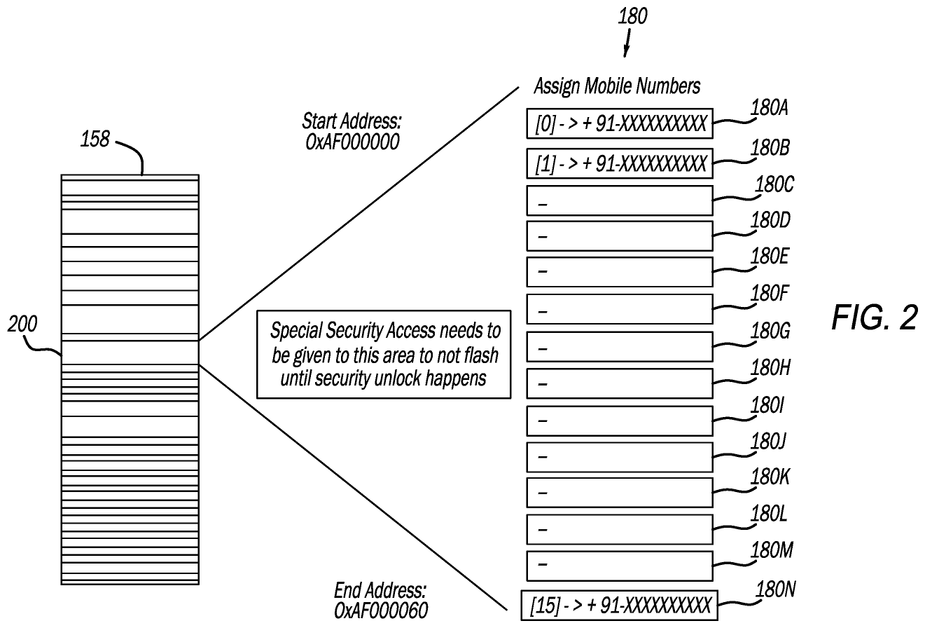

With continued reference to FIG. 1 and additional reference to FIG. 2, the memory 158 of the infotainment system 128 will be further described. The memory 158 of the infotainment system 128 can be configured to store various user settings, applications, media and other information. One area of the memory 158 can include a non-volatile memory (NVM) module 200. The NVM module 200 can include a guarded bootloader memory section that can store the vehicle owner's mobile number. In the example shown, the NVM module 200 is configured to store a plurality of authorized mobile numbers collectively shown at reference 180 and individually shown at 180A-180N.

In use, a vehicle owner assigns various mobile numbers 180 to be authorized for pairing with the infotainment system 128 of the vehicle 100. As will be described herein, should a candidate mobile device having an unauthorized number be paired with the infotainment system 128, the present disclosure alerts the vehicle owner of a breach and also sets a vehicle stolen diagnostic trouble code (DTC). As is known, when a technician connects to the vehicle during service, such as through an on board diagnostic (OBD) port, various codes that have been set can be read. If a security breach has been detected by an unauthorized mobile device being paired to the infotainment system 128, the technician is made aware of such breach by the vehicle stolen DTC.

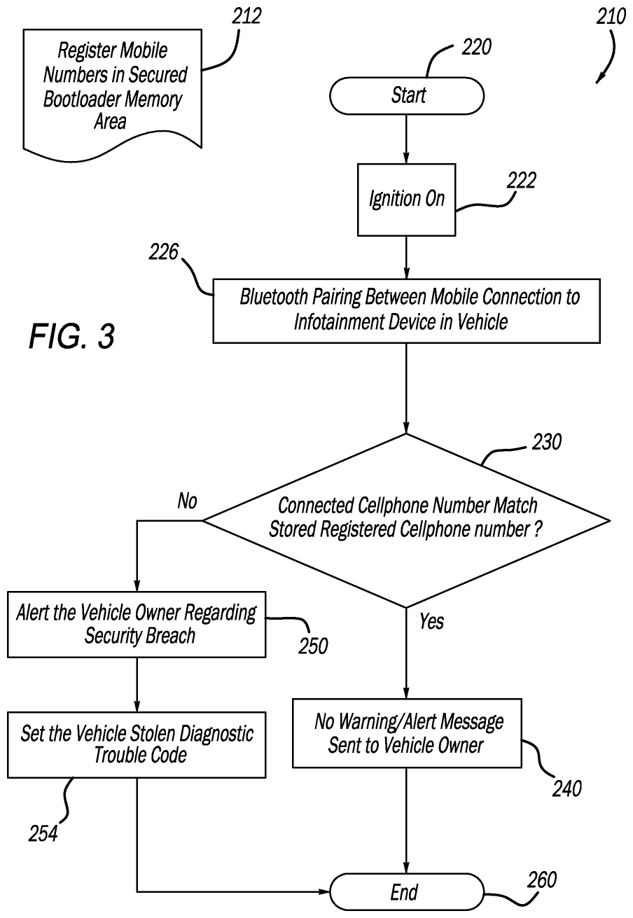

With particular reference now to FIG. 3, a method for identifying a vehicle security breach and alerting a vehicle owner of same is shown and generally identified at reference numeral 210. At 212, the user registers the mobile numbers 180 in the secured bootloader memory module 160 of the infotainment memory 158. As identified above, the memory module 200 can be configured to store as many or as few mobile numbers as needed. It is appreciated however that the memory module 200 will be configured to store at least the vehicle owners mobile number at 180A. It will be appreciated that the vehicle owner can change or update the mobile numbers in the memory 158. In examples, the memory 158 can be accessed securely only by an authorized user such as through an authentication process with a software key. Moreover, should the vehicle be sold to another owner, the new owner will be able to update the mobile numbers in the memory 158 accordingly.

The method starts at 220. At 222 control determines whether the vehicle ignition is on. At 226 a Bluetooth pairing between a candidate mobile device and the infotainment system 128 occurs. At 230 control determines whether the candidate mobile device 182 satisfies a stored registered (authorized) mobile number. If the candidate mobile device 182 satisfies a stored and authorized mobile number, control proceeds to 240 where normal Bluetooth mobile device interaction with the infotainment system 128 is permitted. It is appreciated that during normal pairing, various transfers of data occur between the mobile device 182 and the infotainment system 128. By way of example only, data may be communicated through Object Exchange (OBEX) protocol that facilitates binary transfers between Bluetooth enabled devices.

If the candidate mobile device 182 does not satisfy a stored registered mobile number at 240, the vehicle owner is alerted regarding the security breach at 250. The vehicle owner can be alerted such as by the controller 120 using the communication system 104 to send an alert to the secure server 176 that communicates the alert back to the vehicle owner. By way of example, a vehicle owner can be alerted such as by text message or phone call to the mobile number associated with the stored mobile number 180A in the NVM module 200. The alert can be initiated through the cellular network 168 by the secure server 176. Other methods of alerting the vehicle owner are contemplated.

In examples, the communication system 104 can provide vehicle location information to the secure server 176. At 254, control sets the vehicle stolen diagnostic trouble code (DTC). It is appreciated that the stolen DTC would be downloaded and read by any diagnostic tool such as when a vehicle is serviced. Such a DTC would alert a service garage that the vehicle is identified as stolen. Supplemental security protocols could be acted upon by the service garage. The method ends at 260.

It will be appreciated that the term “controller” as used herein refers to any suitable control device or set of multiple control devices that is/are configured to perform at least a portion of the techniques of the present disclosure. It will further be appreciated that while the controller 120 has been depicted as a standalone component, the controller 120 can additionally or alternatively be incorporated at the infotainment system 128. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A security system for identifying a security breach of a vehicle, the system comprising:
an infotainment system having a display and configured to receive user inputs;
a memory that receives and stores data at the infotainment system, wherein the memory is configured to receive and store at least one authorized mobile number associated with the vehicle; and
a controller that (i) determines whether a candidate mobile device has been paired to the infotainment system, (ii) compares a mobile number of the candidate mobile device with the at least one authorized mobile number, (iii) determines a security breach has occurred based on the mobile number of the candidate mobile device not matching at least one authorized mobile number, and (iv) performs a notification action based on the security breach.

2. The security system of claim 1, wherein the notification action comprises alerting a vehicle owner based on the security breach.

3. The security system of claim 2, further comprising a communication system that sends an alert indicative of the security breach to a secure server through a cellular network.

4. The security system of claim 3, wherein the communication system is configured to communicate a vehicle location to the secure server based on the security breach.

5. The security system of claim 2, wherein the controller is further configured to set a vehicle stolen diagnostic trouble code based on the security breach.

6. The security system of claim 1, wherein the memory comprises a non-volatile memory (NVM) module.

7. The security system of claim 6, wherein the NVM module includes a guarded bootloader memory that stores the at least one authorized mobile number.

8. The security system of claim 1, wherein the at least one authorized mobile number comprises at least five authorized mobile numbers.

9. The security system of claim 8, wherein the at least one authorized mobile number comprises fifteen authorized mobile numbers.

10. A method for identifying a security breach of a vehicle, the method comprising:
receiving, at an infotainment system of the vehicle, at least one authorized mobile number;
storing, at a memory of the infotainment system, the at least one authorized mobile number;
determining, at a controller, that a candidate mobile device has been successfully paired to the infotainment system;
comparing a mobile number of the candidate mobile device with the at least one authorized mobile number;
determining whether a security breach has occurred based on the mobile number of the candidate mobile device not matching at least one authorized mobile number; and
performing a notification action based on the security breach.

11. The method of claim 10, wherein performing the notification action comprises sending an alert to a vehicle owner based on the security breach.

12. The method of claim 11, further comprising:
sending an alert indicative of the security breach to a secure server through a cellular network.

13. The method of claim 12, further comprising:
communicating a vehicle location to the secure server based on the security breach.

14. The method of claim 13, further comprising:
setting a vehicle stolen diagnostic trouble code based on the security breach.

15. The method of claim 10 wherein storing the at least one authorized mobile number comprises storing the at least one authorized mobile number at a non-volatile memory (NVM) module.

16. The method of claim 15 wherein storing the at least one authorized mobile number comprises storing the at least one authorized mobile number at a guarded bootloader memory.

17. The method of claim 16, further comprising updating the stored authorized mobile number subsequent to an authentication process.

18. The method of claim 10, wherein storing the at least one authorized mobile number comprises storing at least five authorized mobile numbers.
